(19) United States
(12) Patent Application Publication
(10) Pub. No.: US 2024/0193969 A1
(43) Pub. Date: Jun. 13, 2024

(54) METHOD FOR CREATING MULTIMODAL TRAINING DATASETS FOR PREDICTING USER CHARACTERISTICS USING PSEUDO-LABELING

(71) Applicant: Korea Electronics Technology Institute, Seongnam-si (KR)

(72) Inventors: Jae Woong YOO, Seongnam-si (KR); Mi Ra LEE, Hwaseong-si (KR); Hye Dong JUNG, Seoul (KR)

(73) Assignee: Korea Electronics Technology Institute, Seongnam-si (KR)

(21) Appl. No.: 18/536,856

(22) Filed: Dec. 12, 2023

(30) Foreign Application Priority Data
Dec. 13, 2022 (KR) 10-2022-0173473
Mar. 21, 2023 (KR) 10-2023-0036768

(51) Int. Cl. G06V 20/70; G06V 10/44; G06V 10/74

(52) U.S. Cl. CPC G06V 20/70; G06V 10/44; G06V 10/761

(57) ABSTRACT

There is provided a method for creating multimodal training datasets for predicting characteristics of a user by using pseudo-labeling. According to an embodiment, the method may acquire a labelled dataset in which an image of a user is labelled with personality information and may extract a multimodal feature vector from the image of the acquired labelled dataset, may acquire an un-labelled dataset in which an image of a user is not labelled with personality information and may extract a multimodal feature vector from the image of the acquired un-labelled dataset, may measure a similarity between the extracted multimodal feature vector of the labelled dataset and the multimodal feature vector of the un-labelled dataset, and may label the un-labelled dataset based on the measured similarity. Accordingly, by creating multimodal training datasets for predicting a user personality by using pseudo-labeling, training datasets may be obtained rapidly, economically and effectively.

### CROSS-REFERENCE TO RELATED APPLICATION(S) AND

### Claim of Priority

This application is based on and claims priority under 35 U.S.C. § 119 to Korean Patent Application No. 10-2022-0173473, filed on Dec. 13, 2022, and Korean Patent Application No. 10-2023-0036768, filed on Mar. 21, 2023, in the Korean Intellectual Property Office, the disclosure of which is herein incorporated by reference in its entirety.

### BACKGROUND

### Field

The disclosure relates to a method for creating multimodal training datasets, and more particularly, to a method for creating multimodal training datasets which are necessary for training a model for predicting a personality or characteristic of a user.

### Description of Related Art

Thanks to the convergence of platforms and development of technologies, user-customized services which understand attributes of humans and suggest technologies most appropriate or suited to environments are enhanced rapidly.

Accordingly, definitions and meanings of computing, interfaces, etc. between a user and a system are extended, and the field of interaction between humans and computers perform an important role in researching ways of enabling users to interact with systems easily and comfortably.

In particular, as hardware capable of storing and utilizing huge amounts of data is rapidly developing, the importance of a task of understanding users' behavior and emotion and predicting by using individual information of users is stressed.

A human personality may be an essential element to understand and predict a user, and may be an index for expressing a human changing every time. Accordingly, there is a need for a solution for predicting a changeable personality of a user which is exhibited in various environments.

It is possible to predict a personality by using text, audio, video information of a user, but the problem is that there are not enough training datasets. There is a method for developers to create training datasets by directly labeling, but this method is not desirable in terms of efficiency and economic aspects.

The above problem may be solved if training datasets are augmented, but the accuracy of learning and efficiency may not be guaranteed since augmented datasets are very similar to already-established training datasets.

### SUMMARY

The disclosure has been developed in order to solve the above-described problems, and an object of the disclosure is to provide a method for creating multimodal training datasets for predicting characteristics or personality of a user by using pseudo-labeling.

According to an embodiment of the disclosure to achieve the above-described object, a training data creation method may include: a step of acquiring a labelled dataset in which an image of a user is labelled with personality information; a step of extracting a multimodal feature vector from the image of the acquired labelled dataset; a step of acquiring an un-labelled dataset in which an image of a user is not labelled with personality information; a step of extracting a multimodal feature vector from the image of the acquired un-labelled dataset; a step of measuring a similarity between the extracted multimodal feature vector of the labelled dataset and the multimodal feature vector of the un-labelled dataset; and a step of labeling the un-labelled dataset based on the measured similarity.

The step of labeling may include, only when the similarity is greater than a threshold value, labeling the un-labelled dataset by using the label of the labelled dataset as a pseudo-label.

The step of extracting may include: a step of extracting multimodal information from an image; a step of extracting feature vectors from the extracted multimodal information; and a step of generating a multimodal feature vector by integrating the extracted feature vectors. The step of generating may include integrating the extracted feature vectors through one of concatenation, averaging, and mixing using multi-layer perceptron (MLP).

The multimodal information may include visual information, voice information, and text information, and the text information may include an utterance text and caption information.

The step of measuring may include measuring the similarity between the multimodal feature vectors by using a cosine similarity between the multimodal feature vectors or a mean absolute error (MAE) between vector components.

The training data creation method may further include: a step of masking a part of the labelled datasets with a label; a step of extracting a multimodal feature vector from the dataset masked with the label; a step of labeling the dataset masked with the label with a pseudo-label, based on a similarity to a multimodal feature vector of the labelled dataset that is not masked with the label; and a step of verifying pseudo-labeling by comparing the pseudo-label with an original label before masking.

According to an embodiment of the disclosure, the training data creation method may further include a step of creating training datasets by mixing the labelled datasets and the pseudo-labelled datasets. The step of creating may include determining a ratio between the labelled datasets and the pseudo-labelled datasets, based on a similarity between a distribution of the labelled datasets and a distribution of the pseudo-labelled datasets.

According to another embodiment of the disclosure, a training data creation system may include: a first acquisition unit configured to acquire a labelled dataset in which an image of a user is labelled with personality information; a first extraction unit configured to extract a multimodal feature vector from the image of the acquired labelled dataset; a second acquisition unit configured to acquire an un-labelled dataset in which an image of a user is not labelled with personality information; a second extraction unit configured to extract a multimodal feature vector from the image of the acquired un-labelled dataset; a measurement unit configured to measure a similarity between the extracted multimodal feature vector of the labelled dataset and the multimodal feature vector of the un-labelled dataset; and a labeling unit configured to label the un-labelled dataset based on the measured similarity.

According to still another embodiment of the disclosure, a training dataset creation method may include: a step of measuring a similarity between a multimodal feature vector which is extracted from a labelled dataset in which an image of a user is labelled with personality information, and a multimodal feature vector which is extracted from an un-labelled dataset in which an image of a user is not labelled with personality information; a step of labeling the un-labelled dataset based on the measured similarity; and a step of creating training data for a model for predicting a personality of a user, by mixing the labelled datasets and un-labelled datasets.

According to yet another embodiment of the disclosure, a training dataset creation system may include: a measurement unit configured to measure a similarity between a multimodal feature vector which is extracted from a labelled dataset in which an image of a user is labelled with personality information, and a multimodal feature vector which is extracted from an un-labelled dataset in which an image of a user is not labelled with personality information; a labeling unit configured to label the un-labelled dataset based on the measured similarity; and a creation unit configured to create training data for a model for predicting a personality of a user, by mixing the labelled datasets and un-labelled datasets.

As described above, according to embodiments of the disclosure, by creating multimodal training datasets for predicting a user personality by using pseudo-labeling, training datasets may be obtained rapidly, economically and effectively.

In addition, according to embodiments of the disclosure, when training datasets are constituted based on obtained datasets, a configuration/ratio of a labelled dataset and a pseudo-labelled dataset is appropriately determined, so that degradation of the effect of training a personality prediction model may be minimized.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a view illustrating a configuration of a system for creating training datasets for predicting a user personality according to an embodiment of the disclosure;

FIG. 2 is a view illustrating a process of extracting a multimodal feature vector regarding a labelled dataset;

FIG. 3 is a view illustrating a process of extracting a multimodal feature vector regarding an un-labelled dataset;

FIG. 4 is a view illustrating a process of measuring a similarity and labeling; and

FIG. 5 is a view illustrating a method of mixing a labelled dataset and a pseudo-labelled dataset to create training datasets.

### DETAILED DESCRIPTION

Hereinafter, the disclosure will be described in more detail with reference to the accompanying drawings.

Embodiments of the disclosure provide a method for creating multimodal training datasets for predicting user characteristics by using pseudo-labeling. The disclosure relates to a technology for labeling an un-labelled dataset with a label of a labelled dataset through pseudo-labeling when the un-labelled dataset is similar to the labelled dataset in multimodal features, which are a basis for predicting a user personality, and using the datasets as training datasets.

Based on the assumption that a person who has a similar personality has a similar action pattern, an image that is not labeled with personality information of a user is given a label of an image showing a similar action pattern as a pseudo-label, so that more training datasets may be obtained for enhancing performance of a personality prediction model.

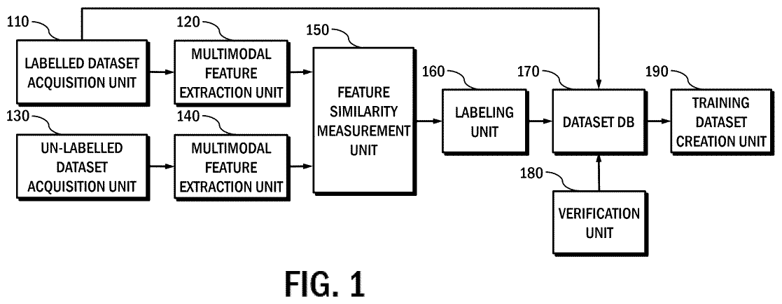

FIG. 1 is a view illustrating a configuration of a training dataset creation system for predicting a user personality according to an embodiment of the disclosure. The training dataset creation system according to an embodiment may include a labelled dataset acquisition unit 110, a multimodal feature extraction unit 120, an un-labelled dataset acquisition unit 130, a multimodal feature extraction unit 140, a feature similarity measurement unit 150, a labeling unit 160, a dataset database (DB) 170, a verification unit 180, and a training dataset creation unit 190.

The labelled dataset acquisition unit 110 acquires a dataset in which an image of a user is labelled with personality information. The multimodal feature extraction unit 120 extracts a multimodal feature vector from the user image acquired through the labelled dataset acquisition unit 110.

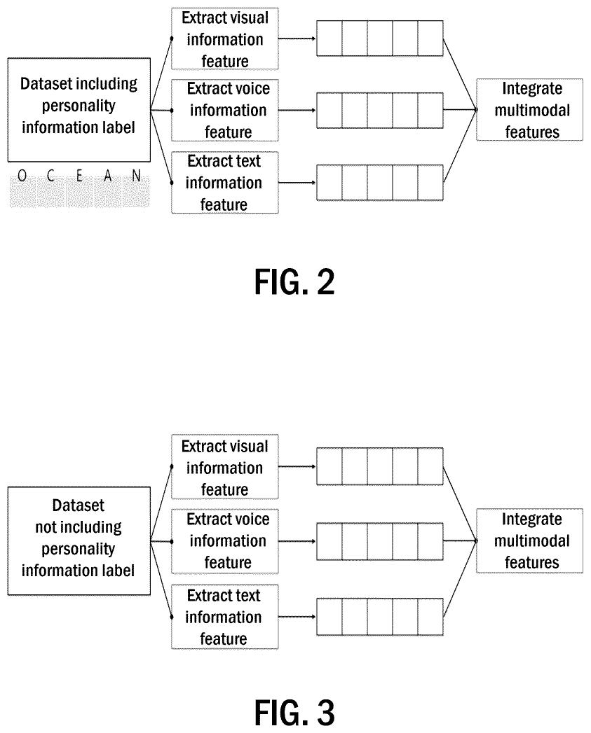

FIG. 2 illustrates a process of extracting a multimodal feature vector by the multimodal feature extraction unit 120.

In order to extract multimodal features, the multimodal feature extraction unit 120 may extract multimodal information from a user image, first. Multimodal information extracted may include visual information, voice information, and text information.

The visual information refers to information on a facial area, an ambient environment or a background area extracted from an image. The voice information is an uttered voice of a user that is extracted from an image. The text information includes an utterance text and caption information. The utterance text is a text that is generated by converting an uttered voice of a user through speech-to-text (STT), and the caption information is a text indicating a facial expression of a user, an ambient object, a situation which are derived from an image through video captioning.

The multimodal feature extraction unit 120 extracts features regarding visual information, voice information, utterance text, and caption information which are multimodal information, respectively, and integrates the extracted multimodal features into one vector.

Multimodal features may be integrated through concatenation, averaging, mixing using multi-layer perceptron (MLP).

Concatenation is a method for integrating respective modality feature vectors by physically connecting to maintain one dimension thereof. Averaging is a method for integrating modality features while maintaining an original vector size by averaging respective elements of the modality feature vectors.

Mixing using MLP is a method for mixing respective modality feature vectors to integrate into one feature vector by passing through a hidden dimension of MLP which is a feed-forward artificial neural network. When this method is applied, three input vectors may be integrated into one vector.

The un-labelled dataset acquisition unit 130 acquires a dataset in which an image of a user is not labelled with personality information. The multimodal feature extraction unit 140 extracts a multimodal feature vector from the image acquired through the un-labelled dataset acquisition unit 130.

FIG. 3 illustrates a process of extracting a multimodal feature vector by the multimodal feature extraction unit 140. A method for extracting a multimodal feature vector of an un-labelled dataset is the same as the method for extracting a multimodal feature vector of a labelled dataset, and thus reference is made to the description of FIG. 2.

The feature similarity measurement unit 150 measures a similarity between the ‘multimodal feature vector extracted from the image of the labelled dataset by the multimodal feature extraction unit 130’ and the ‘multimodal feature vector extracted from the image of the un-labelled dataset by the multimodal feature extraction unit 140’.

A similarity between feature vectors may be measured through cosine similarity measurement, inter-vector component mean absolute error (MAE) measurement.

A cosine similarity indicates a degree of similarity between feature vectors by using a cosine value of an angle between two feature vectors in an internal space. As a similarity is higher, a cosine similarity value is closer to 1, and, as a similarity is lower, a cosine similarity value is closer to −1.

Inter-vector component MAE measurement measures a degree of similarity between two feature vectors by calculating a MAE between components existing in the same row and the same column in two feature vectors. As a similarity is higher, a MAE is closer to 0, and, as a similarity is lower, a MAE is higher.

The labeling unit 160 may label the un-labelled dataset acquired by the un-labelled dataset acquisition unit 130, based on a similarity measured by the feature similarity measurement unit 150.

Specifically, when the similarity is greater than a threshold value, that is, when it is determined that the two multimodal feature vectors are similar, the labeling unit 160 may label the un-labelled dataset by using the personality information labeled for the labelled dataset as a pseudo label.

On the other hand, when the similarity is less than the threshold value, that is, when it is determined that the two multimodal feature vectors are not similar, the labeling unit 160 may not label the un-labelled dataset with the personality information labeled for the labelled dataset.

That is, the labeling unit 160 may label the un-labelled dataset with the personality information of the labelled dataset through pseudo labeling only when the multimodal feature vector of the un-labelled dataset and the multimodal feature vector of the labelled dataset are similar to each other.

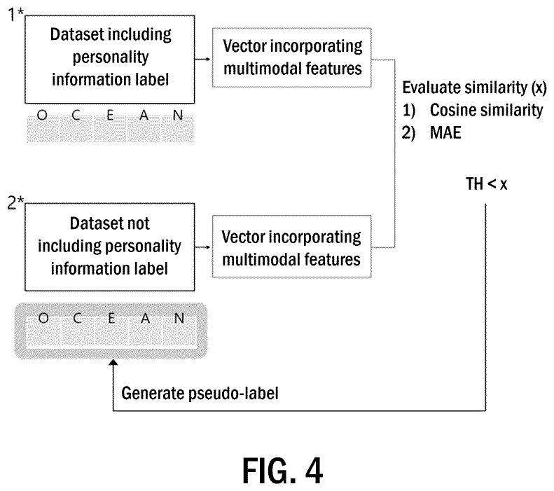

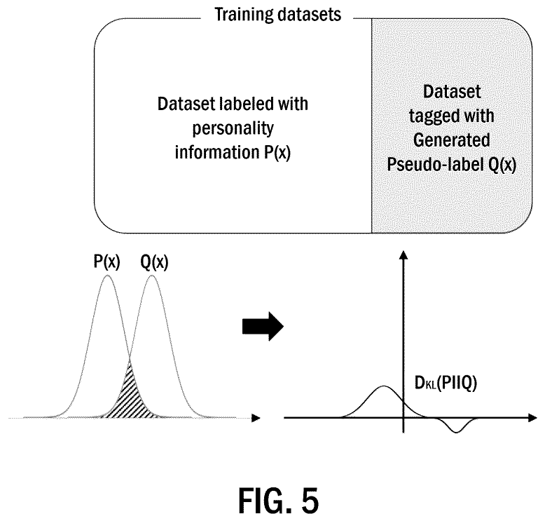

FIG. 4 illustrates a concept of measuring a similarity by the feature similarity measurement unit 150 and labeling by the labeling unit 160. Specifically, FIG. 4 illustrates a process of measuring a similarity between a multimodal feature vector extracted from an image of a labelled-dataset 1* and a multimodal feature vector extracted from an image of an un-labelled dataset 2*, comparing the measured similarity with a threshold value, and labeling the un-labelled dataset with a pseudo label selectively according to the result of comparing.

Referring back to FIG. 1, in the dataset DB 170, labelled datasets acquired by the labelled dataset acquisition unit 110, that is, datasets originally labelled with personality information, and datasets that are acquired by the un-labelled dataset acquisition unit 130 and then are labelled with pseudo-labels by the labeling unit 160 are accumulated.

The verification unit 180 verifies whether similarity measurement by the feature similarity measurement unit 150 and labeling by the labeling unit 160 are reliably performed. A verification procedure may be performed as follows.

1) First, the verification unit 180 selects only labelled datasets among the labelled datasets and the pseudo-labelled datasets which are accumulated in the dataset DB 170.

2) The verification unit 180 masks a half of the labelled datasets selected at ‘1)’ with labels.

3) The verification unit 180 labels the datasets masked with the labels with pseudo-labels according to the method suggested in FIG. 4. In this process, labelled datasets that are not masked with labels at ‘2)’ become labelled datasets (1*), and datasets that are masked with labels at ‘2)’ become un-labelled datasets (2*).

4) Finally, the verification unit 180 calculates a MAE between the pseudo-labels labelled for the datasets masked with the labels, and an original label before masking, and verifies reliability on similarity measurement by the feature similarity measurement unit 150 and labeling by the labeling unit 160.

The training dataset creation unit 190 creates training datasets by using the datasets accumulated in the dataset DB 170. The training datasets are constituted by mixing the labelled dataset and the pseudo-labelled dataset. In this case, the training dataset creation unit 190 may determine a ratio between the labelled dataset and the pseudo-labelled dataset based on a distribution similarity between a distribution of the labelled datasets and a distribution of the pseudo-labelled datasets.

Specifically, the training dataset creation unit 180 may create training datasets with a label (personality information) distribution P(x) of labelled-datasets and a label distribution Q(x) of pseudo-labelled datasets which make the KL-divergence greatest.

Up to now, a method for creating multimodal training datasets for predicting a user personality by using pseudo-labeling has been described with reference to preferred embodiments.

In embodiments of the disclosure, considering that multimodal data is high-cost and low-efficiency data in acquiring, a pseudo-label is generated for data that is not labelled with personality information, based on a similarity between vectors incorporating visual, voice information.

Based on the assumption that a person who has similar personality and action characteristics has similar action patterns, various images from which user's characteristic information is not identified are obtained and then a pseudo-label is generated, so that more training datasets may be used for enhancing performance of a personality prediction model.

In an embodiment, user personality information corresponding to a label which is presented as a prediction target is merely an example. The technical concept of the disclosure may be applied when training datasets for a model for predicting other characteristics than a user personality are created.

The technical concept of the disclosure may be applied to a computer-readable recording medium which records a computer program for performing the functions of the apparatus and the method according to the present embodiments. In addition, the technical idea according to various embodiments of the disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the present disclosure have been illustrated and described, the present disclosure is not limited to the above-described specific embodiments. Various changes can be made by a person skilled in the at without departing from the scope of the present disclosure claimed in claims, and also, changed embodiments should not be understood as being separate from the technical idea or prospect of the present disclosure.

What is claimed is:

1. A training data creation method comprising:
a step of acquiring a labelled dataset in which an image of a user is labelled with personality information;
a step of extracting a multimodal feature vector from the image of the acquired labelled dataset;
a step of acquiring an un-labelled dataset in which an image of a user is not labelled with personality information;
a step of extracting a multimodal feature vector from the image of the acquired un-labelled dataset;
a step of measuring a similarity between the extracted multimodal feature vector of the labelled dataset and the multimodal feature vector of the un-labelled dataset; and
a step of labeling the un-labelled dataset based on the measured similarity.

2. The training data creation method of claim 1, wherein the step of labeling comprises, only when the similarity is greater than a threshold value, labeling the un-labelled dataset by using the label of the labelled dataset as a pseudo-label.

3. The training data creation method of claim 2, wherein the step of extracting comprises:
a step of extracting multimodal information from an image;
a step of extracting feature vectors from the extracted multimodal information; and
a step of generating a multimodal feature vector by integrating the extracted feature vectors.

4. The training data creation method of claim 3, wherein the step of generating comprises integrating the extracted feature vectors through one of concatenation, averaging, and mixing using MLP.

5. The training data creation method of claim 3, wherein the multimodal information includes visual information, voice information, and text information, and
wherein the text information includes an utterance text and caption information.

6. The training data creation method of claim 2, wherein the step of measuring comprises measuring the similarity between the multimodal feature vectors by using a cosine similarity between the multimodal feature vectors or a MAE between vector components.

7. The training data creation method of claim 2, further comprising:
a step of masking a part of the labelled datasets with a label;
a step of extracting a multimodal feature vector from the dataset masked with the label;
a step of labeling the dataset masked with the label with a pseudo-label, based on a similarity to a multimodal feature vector of the labelled dataset that is not masked with the label; and
a step of verifying pseudo-labeling by comparing the pseudo-label with an original label before masking.

8. The training data creation method of claim 7, further comprising a step of creating training datasets by mixing the labelled datasets and the pseudo-labelled datasets.

9. The training data creation method of claim 8, wherein the step of creating comprises determining a ratio between the labelled datasets and the pseudo-labelled datasets, based on a similarity between a distribution of the labelled datasets and a distribution of the pseudo-labelled datasets.

10. A training data creation system comprising:
a first acquisition unit configured to acquire a labelled dataset in which an image of a user is labelled with personality information;
a first extraction unit configured to extract a multimodal feature vector from the image of the acquired labelled dataset;
a second acquisition unit configured to acquire an un-labelled dataset in which an image of a user is not labelled with personality information;
a second extraction unit configured to extract a multimodal feature vector from the image of the acquired un-labelled dataset;
a measurement unit configured to measure a similarity between the extracted multimodal feature vector of the labelled dataset and the multimodal feature vector of the un-labelled dataset; and
a labeling unit configured to label the un-labelled dataset based on the measured similarity.

11. A training data creation method comprising:
a step of measuring a similarity between a multimodal feature vector which is extracted from a labelled dataset in which an image of a user is labelled with personality information, and a multimodal feature vector which is extracted from an un-labelled dataset in which an image of a user is not labelled with personality information;
a step of labeling the un-labelled dataset based on the measured similarity; and
a step of creating training data for a model for predicting a personality of a user, by mixing the labelled datasets and un-labelled datasets.
